(19) United States
(12) Patent Application Publication
(10) Pub. No.: US 2021/0291349 A1
(43) Pub. Date: Sep. 23, 2021

(54) HAND TOOL WITH REPLACEABLE TOOL HEAD

(71) Applicant: Victorio Gutierrez, Bakersfield, CA (US)

(72) Inventor: Victorio Gutierrez, Bakersfield, CA (US)

(21) Appl. No.: 17/303,913

(22) Filed: Jun. 10, 2021

Related U.S. Application Data
(63) Continuation-in-part of application No. 29/709,486, filed on Oct. 15, 2019, now Pat. No. D923439.
Application No. 29/709,486 is a continuation-in-part of application No. 29/730,476, filed on Apr. 4, 2020, now Pat. No. D923440.
(60) Provisional application No. 63/048,226, filed on Jul. 6, 2020.

(51) Int. Cl. B25G 3/36; B25G 3/34

(52) U.S. Cl. CPC B25G 3/36; B26B 23/00; B25G 3/34

(57) ABSTRACT

A modified hand tool for remote location use such as trail maintenance or fighting forest or brush fires. The hand tool can be fitted with replaceable tool heads and is designed so that the tool head can not slide off the handle in either direction.

### FIELD OF THE INVENTION

The present invention relates to the field of heavy-duty outdoor hand tools.

### BACKGROUND

A multipurpose hand tool is typically desired for chopping, grubbing, clearing or digging up roots and stumps, for trail building or to combat wildfires. Most trails are constructed in remote geographical areas, where crews must hike into by foot and carry gear and a few selected tools that may meet their job expectation for the day. Thus, because of the remote locations involved, weight and volume of a user's equipment are precious commodities.

In small mountain communities, local mountain biking enthusiasts use grubbing tools to build trails. The U.S. Forest Service, Bureau of Land Management (BLM), and rural county and city fire departments also rely on traditional grubbing tools to combat wildfires, maintain fire brakes and or repair existing trails. It is difficult to carry an assortment of long handled tools, such as axes, shovels, rakes, and hoes to an unknown work site. It is well known that a variety of combination tools are used. A major consideration with respect to hand tool design is the durability of the tool. Specifically, the tool must be made of high quality components which are necessary to handle repetitive percussion strikes upon din, stone, rock and timber, etc. Oftentimes, the most common type of tool failure is separation of the tool head from the handle.

Examples of the hand tools used to combat wildfires or alter terrain are described below.

A McLeod hoe and rake is well known in the prior art, and combines a heavy-duty rake with a large, sturdy hoe. It is a standard tool used to combat and suppress wildfires as well as trail restoration for the U.S. Forest Service and other fire service agencies. The McLeod was designed to rake fire lines with its teeth and cut branches and sod with the sharpened hoe edge, but it is used for other purposes. The tool remove slough and berm from a trail, np or compact tread, and can shape a trail's backslope. McLeods work well for constructing trails through light soils and vegetation. However, it is inefficient in rocky or unusually brushy areas. For these situations, other tools such as a Pulaski (described below), mattock grubbing hoe or pickaxe are often used to chop brush, or pry out rocks and roots out of the soil. The McLeod hoe can thereafter be used to remove the loosened rocks, brush, and roots.

The Pulaski is another prior art combination tool that has an axe and hoe head and is a grubbing tool with two or more different types of tool implements connected with a single handle. The Pulaski is a well-known combination tool used by the U.S. Forest Service firefighters and is commonly referred to as a Pulaski after its designer, Edward Pulaski. The Pulaski is easily adapted for trail work, especially for crews limited to a few tools, or crews with limited situational awareness of what the job will dictate. Pulaski combination tools typically are manufactured pin less, and in most cases, fire agencies require the Pulaski combination tool to be pinned through the tool head portion. Pulaski combination tools also typically have short axe style handles, requiring users to bend over for long periods of time. The Pulaski combination tool can be used as an axe but the ergonomic design of the entire tool as whole is not efficient for this use for extended periods of time. The grubbing portion of the tool is very narrow so scooping material is limited to a small area and may take unnecessary repetition to remove dirt and vegetation than a wider grubbing hoe, therefore causing the user to tire faster.

Another prior art combination tool comprises a grub hoe blade opposite a pick blade. The combination tool, sometimes referred to as a combi tool, is basically a military entrenching tool having a long handle. The combi tool functions as a hoe, pick, or shovel. The combi tool has a longer handle than the Pulaski combination tool and can be combined with other similar tools such as mattocks, adze, grub, and hazel hoes, making the combi tool less strenuous to use and suitable for various functions. The combi tool includes a shovel type blade that is hinged to fold approximately perpendicular with the handle for use as a grubbing tool. When unfolded, the hoe blade functions as a small shovel. Opposite of the folding shovel blade is a pick for softening the ground prior to using the shovel blade. However, its known to break apart around the hinge area with age and when used in heavy duty activities such as to combat wildfires, or in areas where there is heavy roots and rocky terrain.

The mattock grub hoe tool is also preferably made of forged steel making the tools more fatiguing to use. Also, the weight of the grub hoe blade is greater than the weight of the opposite tool head making the grub hoe blade dominant over the opposite tool head. Efforts to improve the grub hoe blade by increasing the width at the distal end results in the tool becoming more dangerous because of the angular acceleration, and the unbalancing effect of the larger blade.

Prior art hand tools used for wildfire suppression or terrain alteration typically have a flared end wooden handle and a metal head having a cylindrical opening for receiving the flared end. The dimensions of the flared end wooden handle and cylindrical opening are designed for frictional engagement with one another. This frictional engagement can loosen over time and undesirably disengage. Some of the known issues causing disengagement are that wood can dry and shrink or the wood can be chewed out slowly with time; or over time usage or the frictional engagement of the metal head to the flared portion of the wood handle will lose integrity as a result of repeated use of the tool. In many products available, an additional locking mechanism such as a steel pin is inserted transversely from a hole in the tool head thru the flared end. The use of steel pins or wedges, which are common in the art, can cause wood failure by propagating cracks with the tools' repeated use and eventually lead to the metal tool heads becoming loose with time.

A need exists for a new hand tool that can easily replace tool heads so that the same tool handle can be used for various work from light garden jobs to heavy root, brush chopping, hard dirt penetration, trenching and able to withstand trail building in rocky terrain and be of greater durability than the present tools available. The tool must be sufficiently light to be used to combat wildfires with relatively superior arduous ergonomic balanced features due to blades being balanced by center of gravity, and handles being longer and stronger.

One prior art tool disclosed in US Pub. No. US 2004/0244117 A1 describes a replaceable tool head attached to a connecting head which is affixed to the end of a handle. The connecting head has a top end plate having four holes positioned about its shaft which align with holes present on a tool head for threadable engagement. The connecting head is driven down upon the proximal end of the handle until the end plate is relatively flush with the top of the handle and thereafter a pin is transversely inserted into the handle to secure the connecting head to the handle. This design is not suitable for heavy duty use because the tool head and connecting head could disengage from the handle during extended heavy use.

### SUMMARY OF THE INVENTION

The present invention relates to a hand tool for remote location use such as trail maintenance or fighting forest or brush fires. The hand tool can be fitted with replaceable tool heads of various designs thus allowing various tool heads to be used with a single handle.

The hand tool comprises an elongated handle, a connecting head permanently affixed to the handle, and a tool head that is removably attached to the connecting head.

The elongated handle has a flared proximal end and a narrower distal end. It is preferably made of wood.

The connecting head comprises a shaft portion and an endplate connected thereto, preferably by welding. Preferably, the shaft portion includes an aperture of a generally oval cylindrical configuration. More preferably, the aperture is tapered within which is positioned the flared proximal end of the elongated handle.

The connecting head is positioned about the flared proximal end by first passing the narrowed distal end of the elongated handle thru the central aperture and sliding the connecting head into position as shown in FIGS. 2-3. The flared proximal end is sized relative to the central aperture so that the connecting head can not slide past the proximal end. In other words, the connecting head can only be positioned about the elongated handle by inserting the narrower distal end of the handle through the central aperture opening nearest the endplate. Assembly of the connecting head to the handle in this manner prevents the connecting head from detaching from the handle and dangerously flying off the proximal end. The endplate further comprises a plurality of alignment holes which are present to align with respective alignment holes present on a corresponding plate section that defines a portion of the tool head. When the alignment holes of the endplate and the tool head are aligned, a threaded bolt can engage each pair of holes and secured into place using a nut.

In one preferred embodiment, the position of the connecting head to the proximate end of the handle defines an annular area which is filled with an adhesive such as an epoxy adhesive and cured. Because of the oval configuration of both the handle and connecting head aperture, more annular space exists between handle and shaft in the longer axial direction and less annular space exists across the narrower distance. In addition, the greater annular space is in the direction of tool head impact. Having a greater thickness of epoxy in the direction of impact serves as a cushion which absorbs and thereby reduces some of the impact force a user's hands would otherwise encounter as a result of the tool head impacting a hard surface.

The connecting head also preferably comprises at least one external rib to provide structural support between the endplate and shaft portion. In another embodiment, the endplate and connecting head can be integral and formed from the same piece of metal.

Workers involved with clearing trails or brush fires must carry in their own tools. As a consequence, it is impracticable to carry in each and every tool desired for a particular task. Handles account for a significant amount of space and weight a worker carries to a remote location. Therefore, my invention provides a hand tool which can use the same elongated handle but can be fitted with removable tool heads which are designed to be threadably attached to the end plate of the connecting head. Thus, a single worker can carry a fully assembled tool along with various tool heads to remote locations and then be able to remove the attached tool head and replace with a different tool head as needed.

In addition, because the tool heads are preferably constructed of steel, a preferred embodiment for the tool head reduces overall weight by having a plurality of drilled areas such as concave indentations or small apertures through the face of the head. Having certain areas of the head with apertures or a thinner thickness than the remaining portions will reduce the weight of the tool head without sacrificing durability. Concave indentations or apertures can be made by drilling into the tool head. Further, the tool head can feature an aperture adjacent to the proximal end of the handle for further weight reduction so long as the diameter of the aperture is not sufficiently large to allow the tool head-connecting head attachment to slide toward the distal end of the handle. Besides a circular design, the aperture could be designed to present an artistic image or other indicia.

Preferably, the wood grain of the handle is set in the most vertical direction and not in an opposite direction that contradicts traditional installation of wooden handle techniques.

When the handle portion of the connecting head is centered in the connecting head, the flared wooden portion is closest to the metal shank at about the 3 o'clock and 9 o'clock positions. Preferably, these sides are the only portions of the shank that contact the handle when centered correctly.

Interchangeable tool heads, which can be used with a single handle, is a more cost effective approach than the purchase of separate tool heads and respective handles. Tool head construction is not limited to a particular design so long as the tool head can be threadably attached to the end plate of the connector head as described herein. Thus, for example, a more traditional axe design can be fashioned to be bolted onto the end plate of the connector head.

Each tool head has a plurality of holes that can be aligned with a respective holes found on the connector head. Once the holes are aligned, bolts and nuts are used to threadably secure the tool head to the connector head. Once secured to the connector head, the tool head can not be disengaged from the handle. As discussed earlier, the flared proximal end of the elongated handle is sufficiently dimensioned to prevent the connecting head from sliding off the handle at the proximal end. Further, since the tool head either has no hole adjacent to the aperture of the shaft portion of the connector head or has a hole smaller in size than the aperture of the shaft portion, it is not possible for the tool head to travel down the length of the handle once it is threadably attached to the connector head. Thus, my invention prevents disengagement of the tool head—connector head attachment from the handle in either direction; transverse pins, or wedges hammered into the proximal end of the handle are no longer necessary.

### DESCRIPTION OF THE DRAWINGS

FIG. 1 is a perspective view of the modified hand tool.

FIG. 2 is a perspective view of assemblying the connecting head to the handle.

FIG. 3 is the position of the connecting head to the handle for epoxy application.

FIG. 4 is an exploded view of the connection of a tool head to the connecting head.

FIG. 5 is a view taken along line 5-5 of FIG. 1.

FIG. 6 is a perspective view of an alternative tool head design.

FIG. 7 is a perspective view of a second alternative tool head design.

### DETAILED DESCRIPTION OF THE PREFERRED EMBODIMENT

The figures presented herein are for illustrative purposes and the illustrated parts are not necessarily shown in correct proportion or scale.

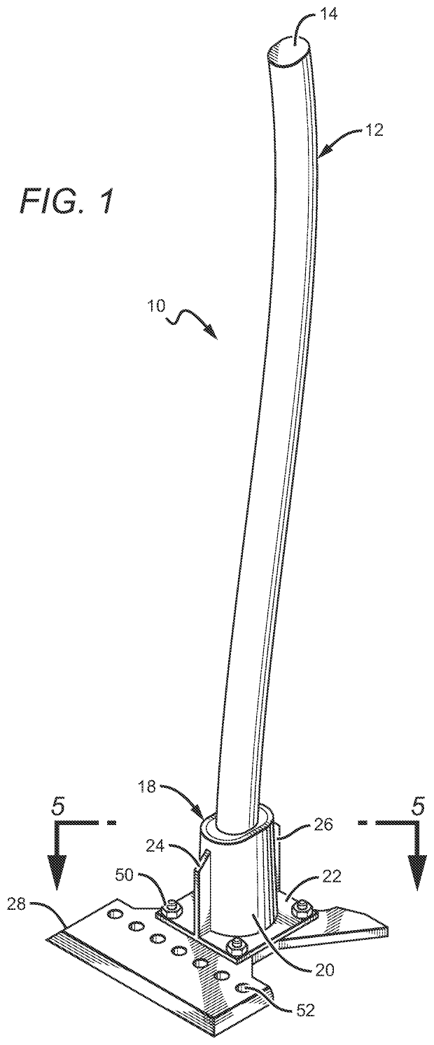

The modified hand tool 10 is illustrated in FIG. 1. Hand tool 10 has an elongated wood handle 12 that has a narrow distal end 14 and a flared proximal end section 16 which is positioned within connecting head 18.

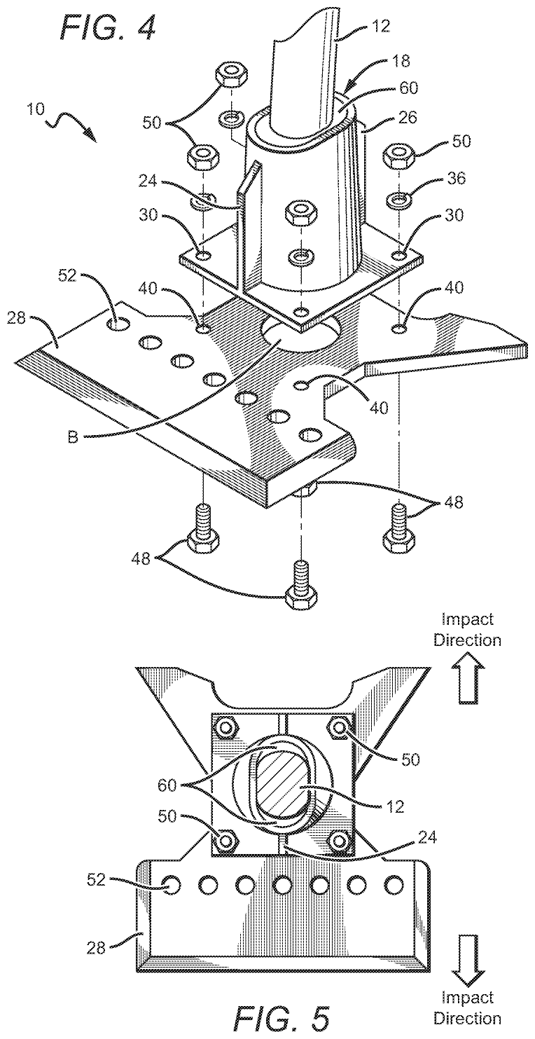

Connecting head 18 comprises a tapered shaft portion 20 and an endplate 22 which is welded thereto. Shaft portion 20 is of a generally oval cylindrical configuration. Ribs 24 provide structural support between shaft portion 20 and end plate 22. As best viewed in FIG. 4, connecting head 18 has a central aperture A which is a generally oval cylindrical configuration that is tapered being wider at the end closest to the tool head 28. Tool head 28 includes hole B which reduces the overall weight of tool head 28. Hole B is smaller than the cross sectional area of flared proximal end 16 to prevent tool head 28 from travel along handle 12.

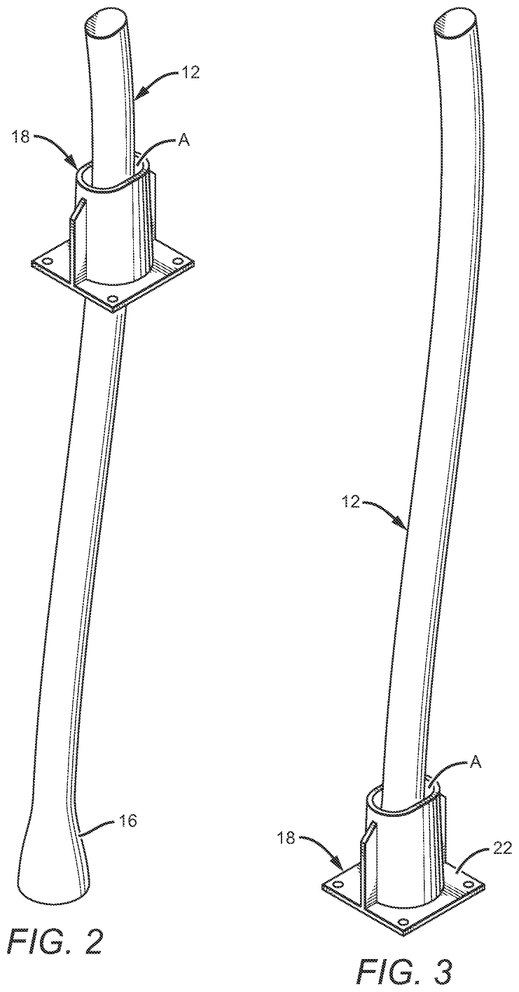

Because of the dimensions of flared proximal end 16 and tapered shaft portion 20, the narrow distal end 14 of handle 12 is first slid through central aperture A as illustrated in FIG. 2 and connecting head 18 is slid down the length of handle 12 until final position as illustrated in FIG. 3.

Once connecting head 18 is in position about flared proximal end 16 of handle 12, epoxy 60 is thereafter inserted to fill the annular space between handle 12 and shaft portion 20. FIG. 5 illustrates the thickness of the epoxy coating relative to the impact direction of tool head 28. Epoxy thickness is greatest at the 12 and 6 o'clock positions which correspond to the impact directions for tool head 28 when it is used to strike the ground or other object. The thicker epoxy in these regions acts as a shock absorber to lessen the impact to the user as the tool head strikes the ground. In addition, there may or may not be epoxy at the 3 and 9 o'clock positions shown in FIG. 5 and will depend upon the thickness of the handle 12 relative to the diameter of shaft portion 20.

Endplate 22 further comprises a plurality of holes 30 which are present to align with respective holes 40 present on tool head 28. When the holes of the endplate and the tool head are aligned, threaded bolt 48 can engage each pair of holes and secure tool head 28 to connecting head 18 using a respective lock washer 36 and nut 50.

Tool head 28 further comprises a plurality of holes 52. These holes are present to reduce the overall weight of tool head 28 without sacrificing structural integrity. The reduced weight makes the improved hand tool 10 easier to handle.

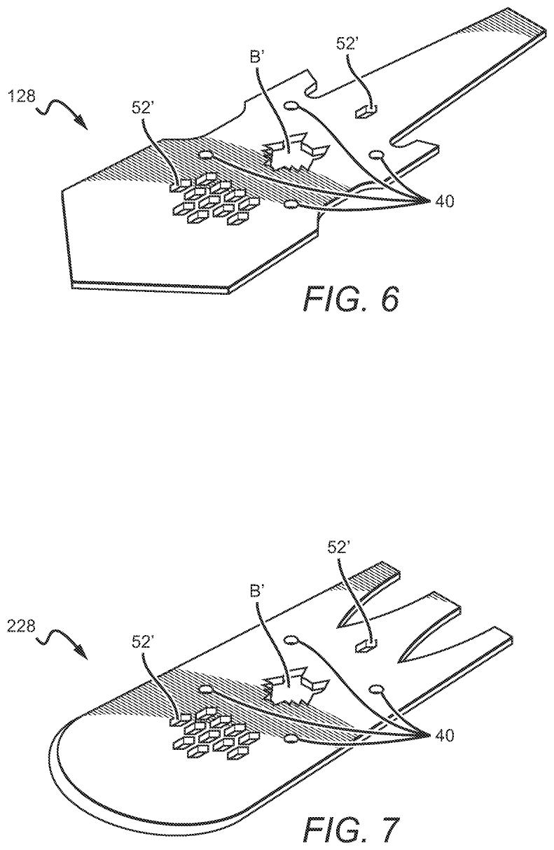

FIG. 6 and FIG. 7 illustrate alternative tool head designs 128 and 228 respectively which can be secured to connecting head 18 and function as a replacement to tool head 28. Holes 52′ are of a different pattern than illustrated by holes 52 but function in the same way to reduce tool head weight. Additionally, Hole B′ illustrates an alternative hole design that function similarly to Hole B. B′ is smaller than the cross sectional area of flared proximal end 16 to prevent tool head 128 or 228 from travel along handle 12.

I claim:

1. A hand tool comprising:
an elongated handle having a flared proximal end;
a connecting head comprising an endplate having a center aperture and a plurality of alignment holes spaced around the center aperture, the connecting head adhesively attached about the flared proximal end of the elongated handle;
a removable tool head having a plurality of alignment holes for alignment with respective alignment holes of the endplate;
a threaded bolt positioned thru each aligned hole of the tool head and endplate to secure the removable tool head to the connecting head; and,
a nut for securing a respective threaded bolt.

2. The hand tool of claim 1 wherein the removable tool head further comprises a plurality of drilled areas in which the wall thickness of the removable head in the drilled areas is less than the thickness of the adjacent area of the removable tool head.

3. A hand tool comprising:
an elongated handle having a flared proximal end;
a connecting head comprising an endplate having a center aperture and a plurality of alignment holes spaced around the center aperture, the connecting head adhesively attached about the flared proximal end of the elongated handle, and where the adhesive between the proximal end and the connecting head is thicker on opposing sides in the impact direction;
a removable tool head having a plurality of alignment holes for alignment with respective alignment holes of the endplate;
a threaded bolt positioned thru each aligned hole of the tool head and endplate to secure the removable tool head to the connecting head; and,
a nut for securing a respective threaded bolt.

4. A hand tool comprising:
an elongated handle having a flared proximal end;
a connecting head comprising a center aperture and an endplate having a plurality of alignment holes spaced around the center aperture, the connecting head adhesively attached about the flared proximal end of the elongated handle;
the flared proximal end of the elongated handle being sufficiently dimensioned to prevent the connecting head from sliding off the handle at the proximal end;
a removable tool head having a plurality of alignment holes for alignment with respective alignment holes of the endplate;
a threaded bolt positioned thru each aligned hole of the tool head and endplate to secure the removable tool head to the connecting head; and,
where the tool head prevents the connecting head from sliding off the handle at the distal end.
